(19) United States
(12) Patent Application Publication
(10) Pub. No.: US 2026/0186914 A1
(43) Pub. Date: Jul. 2, 2026

(54) SYSTEM AND METHOD FOR RESTORING FILES STORED USING FILESYSTEM COMPRESSION FROM BACKUP STORAGE

(71) Applicant: Eon IO, Ltd., Tel Aviv (IL)

(72) Inventors: Assaf NATANZON, Tel Aviv (IL); Dmitry KUZNETSOV, Tel Aviv Yafo (IL); Haim BEN-SHIMOL, Kfar Saba (IL); Ron KIMCHI, Tel Aviv (IL)

(73) Assignee: Eon IO, Ltd., Tel Aviv (IL)

(21) Appl. No.: 19/437,643

(22) Filed: Dec. 31, 2025

Related U.S. Application Data
(63) Continuation-in-part of application No. 19/186,150, filed on Apr. 22, 2025.
Application No. 19/186,150 is a continuation of application No. 19/002,274, filed on Dec. 26, 2024.

(51) Int. Cl. G06F 11/1446

(52) U.S. Cl. CPC G06F 11/1466; G06F 11/1453; G06F 11/1464; G06F 11/1469

(57) ABSTRACT

Systems and methods are disclosed for generating file-level manifest metadata for restoring files stored using filesystem compression. A backup system reads a filesystem on a snapshot to identify files and parses filesystem metadata for a file to determine whether the file data is stored in a compressed format. When compression is indicated, the system identifies physical byte ranges of compressed data and corresponding logical file offset ranges. For each physical byte range, the system determines compression metadata including a compression format identifier and compressed and uncompressed lengths. The system generates and stores a file-level manifest mapping logical file offsets to the physical byte ranges and the compression metadata to enable restoration of the file.

### CROSS-REFERENCE TO RELATED APPLICATION(S)

This application is a continuation-in-part of U.S. Non-Provisional application Ser. No. 19/186,150, filed on Apr. 22, 2025, which is a continuation-in-part of U.S. Non-Provisional application Ser. No. 19/002,274, filed on Dec. 26, 2024, which are all incorporated by reference in their entirety.

### TECHNICAL FIELD

The present disclosure relates generally to backup and restoration of files, and specifically to systems and methods for supporting restoration of files stored using filesystem compression, including dual scanning for both file-level and block-level backups within a deduplicated environment.

### BACKGROUND

File-level and block-level backups are two common strategies for safeguarding data. File-level backups concentrate on copying individual files and their metadata, offering simplicity and quick file-specific restores. However, they can be slower for large datasets and often do not capture system-wide states effectively. Conversely, block-level backups operate on low-level storage blocks, making them efficient for large datasets or minimal data changes, and well-suited for full-system restorations. Yet, block-level solutions lack file-level granularity, making it less straightforward to restore individual files.

One approach combines file-level and block-level scanning to address many challenges of conventional solutions. By performing both types of backup, that approach addresses many challenges of conventional solutions and enables flexible restore capabilities, from individual files to entire systems.

In some approaches, restoring an individual file from a backup may involve mounting a filesystem or restoring a volume image to interpret filesystem structures, which can be time-consuming and resource-intensive.

Further, some filesystems store file data in a compressed representation on disk, and the compression representation may be filesystem-specific. In such scenarios, restoring file data based on physical storage locations may yield data in a compressed form and may not provide information needed to interpret the restored data.

It would therefore be advantageous to provide a backup solution that overcomes the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include reading a filesystem on a snapshot to identify one or more files; parsing filesystem metadata for a file of the one or more files to determine whether data of the file is stored in a compressed format; identifying one or more physical byte ranges of compressed data and corresponding logical file offset ranges for the file in response to determining that data of the file is stored in the compressed format; determining, for each physical byte range of the one or more physical byte ranges; compression metadata including a compression format identifier, a compressed length; and an uncompressed length; generating, in a file-level manifest, a mapping of logical file offsets to the one or more physical byte ranges and the compression metadata; and storing the file-level manifest to enable restoration of the file. Other embodiments of this aspect include corresponding computer systems, apparatus, and computer programs recorded on one or more computer storage devices, each configured to perform the actions of the methods.

Implementations may include one or more of the following features. The method where reading the filesystem on the snapshot includes identifying a file of the one or more files based on a file identifier having at least one of an inode number, a path, or a file record identifier.

The method where determining the compression metadata may include determining the compression metadata per physical byte range.

The method where generating the mapping may include generating one or more extent records, each extent record associating (i) a logical file offset range, (ii) a physical byte range of compressed data, and (iii) compression metadata for decoding the physical byte range.

The method where generating the mapping includes populating a structure having fields for at least one of: a file identifier, a logical offset, an uncompressed length, a physical location, a compressed length, and a compression format identifier.

The method where determining whether data of the file is stored in the compressed format is performed during parsing of the filesystem metadata for the file, and subsequent restore operations rely on stored metadata generated during the parsing rather than determining compression status at restore time.

The method where identifying the one or more physical byte ranges and corresponding logical file offset ranges includes identifying physical extents of compressed data associated with the file and associating each physical extent with a corresponding logical offset range.

The method where parsing the filesystem metadata may include evaluating one or more filesystem-specific indicators of compression stored in on-disk metadata.

The method where the compression metadata further includes one or more decoding parameters that affect decoding of the compressed data. Implementations of the described techniques may include hardware, a method or process, or a computer tangible medium.

In one general aspect, a non-transitory computer-readable medium storing instructions may include one or more instructions that, when executed by one or more processors of a device, cause the device to: read a filesystem on a snapshot to identify one or more files; parse filesystem metadata for a file of the one or more files to determine whether data of the file is stored in a compressed format; identify one or more physical byte ranges of compressed data and corresponding logical file offset ranges for the file in response to determining that data of the file is stored in the compressed format; determine, for each physical byte range of the one or more physical byte ranges. Non-transitory computer-readable medium storing instructions may also include compression metadata including a compression format identifier, a compressed length. Instructions may furthermore include and an uncompressed length; generate, in a file-level manifest, a mapping of logical file offsets to the one or more physical byte ranges and the compression metadata; and store the file-level manifest to enable restoration of the file. Other embodiments of this aspect include corresponding computer systems, apparatus, and computer programs recorded on one or more computer storage devices, each configured to perform the actions of the methods.

In one general aspect, the system may include one or more processors; and a memory storing instructions for generating the file-level manifest including the compression metadata, the instructions, when executed by the one or more processors, cause the system to: read a filesystem on a snapshot to identify one or more files; parse filesystem metadata for a file of the one or more files to determine whether data of the file is stored in a compressed format; identify one or more physical byte ranges of compressed data and corresponding logical file offset ranges for the file in response to determining that data of the file is stored in the compressed format; determine, for each physical byte range of the one or more physical byte ranges, compression metadata including a compression format identifier, a compressed length, and an uncompressed length; generate, in a file-level manifest, a mapping of logical file offsets to the one or more physical byte ranges and the compression metadata; and store the file-level manifest to enable restoration of the file. Other embodiments of this aspect include corresponding computer systems, apparatus, and computer programs recorded on one or more computer storage devices, each configured to perform the actions of the methods.

Embodiments of the present disclosure may be provided as a network of communicating devices (e.g. a “computerized network”). Embodiments of the invention may be also provided as a software application downloadable into a computer device to facilitate the method. The software application may be a computer program product, which may be stored on a non-transitory computer-readable storage medium on a tangible data-storage device (such as a storage device of a server, or one within a user device). In various embodiments, the techniques described herein may be arranged as (i) a method, (ii) a system comprising one or more processing circuitries configured to execute the method, and (iii) a non-transitory computer-readable storage medium storing instructions that, when executed, cause the processing circuitries to perform the method.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

In the drawings:

FIG. 1 is an example schematic diagram of a virtualization including a block-level storage for backup generation, implemented in accordance with an embodiment.

FIG. 2 is an example schematic illustration of a file-level backup utilizing block-level deduplication, implemented in accordance with an embodiment.

FIG. 3 is an example flowchart of a method for performing file-level backup utilizing block-level deduplication, implemented according to an embodiment.

FIG. 4 is an example flowchart of a dual scanning backup method including file-level and block-level processing, implemented in accordance with an embodiment.

FIG. 5 is an example flowchart of a file-level scanning method for identifying and flagging data blocks, implemented in accordance with an embodiment.

FIG. 6 is an example flowchart of a block-level scanning method for processing data blocks not previously flagged by a file-level scan, implemented in accordance with an embodiment.

FIG. 7 is an example flowchart of a method for merging metadata from the file-level and block-level backups, implemented in accordance with an embodiment.

FIG. 8 is an example flowchart of a method for parsing a filesystem on a snapshot to generate a file-level manifest including compression metadata, implemented in accordance with an embodiment.

FIG. 9 is an example schematic illustration of a file-level manifest including a compressed extent table mapping logical file ranges to physical compressed byte ranges, implemented in accordance with an embodiment.

FIG. 10 is an example flowchart of a method for restoring file data stored in a compressed format based on a file-level manifest without mounting the filesystem, implemented in accordance with an embodiment.

FIG. 11 is an example schematic diagram of a backup generator, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

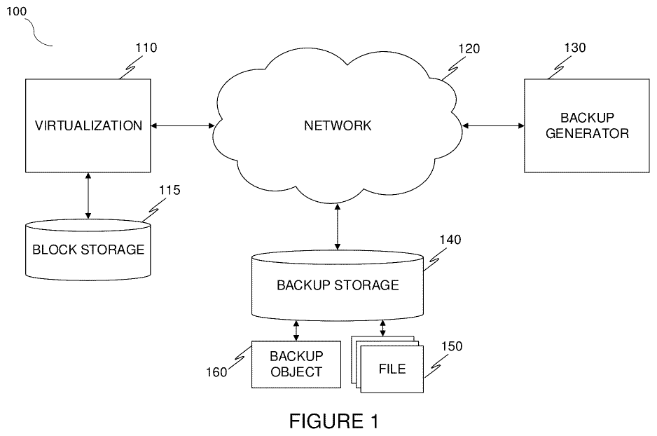

FIG. 1 is an example schematic diagram 100 of a virtualization including a block-level storage for backup generation, implemented in accordance with an embodiment. In an embodiment, a virtualization 110 is a virtual machine, software container, and the like. In some embodiments, the virtualization 110 is associated with a block storage device 115. The backup is of the block storage device 115.

According to an embodiment, the block storage device 115 is configured to store data in fixed-sized blocks, each with a unique address, allowing efficient access and management. Unlike file storage, block storage does not organize data hierarchically, instead leaving structure handling to the operating system, applications, and the like. It is ideal for databases, virtual machines, and high-performance applications. An example is an Amazon® Elastic Block Store (EBS) volume, which provides scalable, block-level storage for use with Amazon Elastic Compute Cloud (EC2) instances.

In an embodiment, the virtualization 110 is deployed in a computing environment that includes a network 120. In some embodiments, the network 120 provides connectivity for the computing environment, utilizing various network interfaces, network protocols, etc.

In some embodiments, the computing environment is an on-prem environment, a hybrid environment, a cloud computing environment, a combination thereof, and the like. A computing environment includes, for example, a virtual private cloud, a virtual network, a virtual private network, a combination thereof, and the like.

According to an embodiment, the cloud computing environment is deployed on a cloud computing infrastructure, such as Amazon® Web Service (AWS), Google® Cloud Platform (GCP), Microsoft® Azure, and the like. In an embodiment, the network further provides connectivity to a backup storage 140 and a backup generator 130. In an embodiment, the backup generator 130 is a computer server implemented, for example, as a virtual machine, a software container, a serverless function, a combination thereof, and the like.

In an embodiment, the backup generator 130 is configured to access the block storage 115 of the virtualization 110, and generate a backup therefrom. In some embodiments, a backup is generated periodically. In certain embodiments, a plurality of periodic backups are generated, each corresponding to a restoration point.

In some embodiments, the backup generator 130 is configured to access a filesystem of the block storage 115. According to an embodiment, a filesystem is a system used by an operating system to organize, store, and retrieve data on storage devices. It manages data as files and directories, keeping track of their locations, sizes, and metadata. Filesystems ensure efficient storage allocation, provide access permissions, and maintain data integrity. Examples include NTFS, ext4, APFS, btrfs, ZFS, and the like. In some embodiments, a filesystem stores at least a portion of file data in a compressed format by the filesystem and maintains on-disk metadata indicating the compressed format by the filesystem.

According to certain embodiments, the backup generator 130 is configured to read files from the block storage 115 and generate a plurality of files 150 as a backup in a backup storage 140. In some embodiments, the plurality of files is stored as objects in the backup storage 140, such as backup object 160.

For example, a backup storage 140 is implemented, in an embodiment, as Amazon® Simple Storage Service (S3). In an embodiment, the backup generator 130 is configured to generate a manifest for each file to indicate where data blocks of the file are stored (e.g., what backup objects a particular file is stored in). In some embodiments, for a file stored in a compressed format by the filesystem, the manifest further indicates physical byte ranges storing compressed data and includes compression metadata for decoding the compressed data. According to an embodiment, the virtualization 110, the backup generator 130, the backup storage 140, a combination thereof, and the like, are deployed in a cloud computing environment.

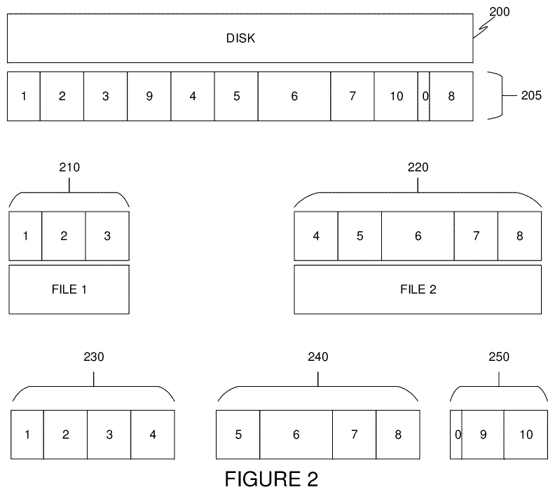

In an embodiment, data blocks of the same file are stored in proximity to each other (e.g., in the same backup object, in backup objects that have proximate addresses, etc.) to minimize the number of objects a file is stored on, which in turn allows for restoration of single files utilizing a minimal amount of compute resources and minimizing the access to different objects. This is explained in more detail with respect to FIG. 2 below.

In some embodiments, a backup (e.g., a restoration point) includes a file-level backup and a block-level backup. In certain embodiments, a file-level backup is initiated first, and once complete, a block-level backup is generated, which is deduplicated based on the file-level backup. This benefits from the advantages of both the file-level backup scheme and the block-level backup scheme.

FIG. 2 is an example schematic illustration of a file-level backup utilizing block-level deduplication, implemented in accordance with an embodiment. In an embodiment, a disk 200 includes a plurality of files. The disk 200 is a block-level storage device and includes a plurality of data blocks 205. In this example, the data blocks are variable-sized and numbered 0 through 10, though in a fragmented order.

In an embodiment, the disk 200 includes a first file 210, which is stored on blocks 1 through 3, and a second file 220 is stored on blocks 4 through 8. By configuring a backup generator to read the filesystem and detect the files, the backup objects 230 through 250 are generated such that they correspond to the file structure.

For example, a first backup object 230 includes blocks 1 through 4, a second backup object 240 includes blocks 5 through 8, and a third backup object 250 includes blocks 0, 9, and 10. In order to restore the first file 230, a manifest associated with the first file is read, and this allows determining that the first backup object 230 is required for restoring the first file 230. It should be noted that several files can be backed up to the same object, and the manifest will point to different locations within the object. Further, a large file may span multiple objects in the backup.

In order to restore the second file 220, it is sufficient to read the first data object 230 and the second data object 240, and there is no need to read the third data object 250, unless a full system restore is required. It should be noted that if a full system restore is required, the data is readily available. Thus, the benefit of both file-level backup and block-level backup is realized when restoring single files or restoring the entire system to an earlier state.

In one embodiment, a snapshot of the virtualization is taken before backing it up. The disks attached to a backup generator are then used to store the backup.

It is important to note that the file system may occupy part of a volume (i.e., a partitioned volume) or span multiple volumes (using a volume manager). In the disclosed embodiments, regardless of the configuration, the file systems on the volume are backed up, and then the entire volume or volumes are backed up. Typically, backup systems create a backup of both the device and the block device. Afterward, these systems generate a list of the files backed up from the block device. During the restoration process, the block device is mounted, and the files are then extracted.

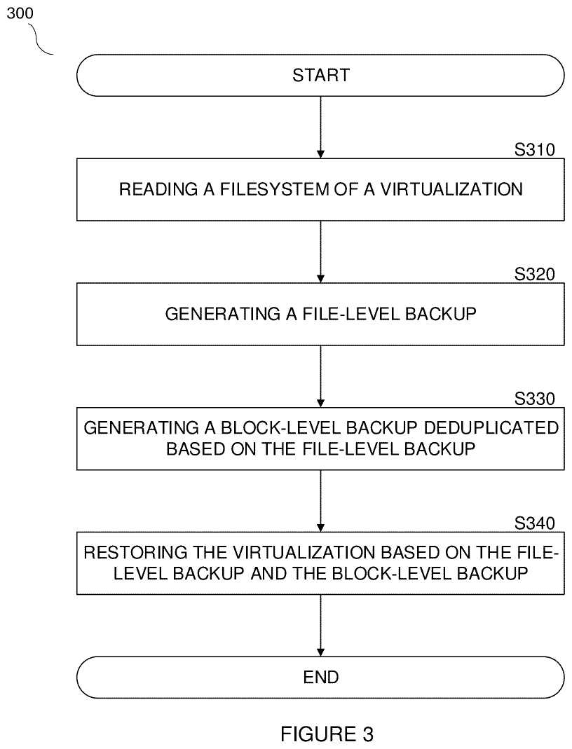

FIG. 3 is a flowchart 300 of a method for performing file-level backup utilizing block-level deduplication, implemented according to an embodiment. In an embodiment, performing file-level backup utilizing block-level deduplication allows for the benefit of the ability to restore single files in an efficient and computationally low-overhead manner, while also providing the speed and accuracy of block-level restoration.

At S310, a filesystem is read. In an embodiment, the filesystem is a block-level storage device of a virtualization deployed in a cloud computing environment. A filesystem is a system that organizes, stores, and manages data on storage devices like hard drives or SSDs. It defines how files are named, stored, retrieved, and accessed, using structures like directories, files, and metadata. Filesystems also handle file permissions, security, and data integrity. Examples include NTFS, ext4, APFS, btrfs, ZFS, and the like.

In an embodiment, the filesystem is read to detect a plurality of files and their locations (i.e., block addresses) in a block-level storage device. In some embodiments, reading the filesystem includes parsing on-disk filesystem metadata to determine whether data of a file is stored in a filesystem-specific compressed format and to identify physical byte ranges associated with the file. In some embodiments, a backup generator is provided with credentials to access a block-level storage device in a cloud computing environment.

At S320, a file-level backup is generated. In an embodiment, the file-level backup is generated for a first time. In some embodiments, the file-level backup includes generating a plurality of backup objects, such as storage blobs. In some embodiments, the backup objects are stored in a cloud storage, such as AWS S3.

In an embodiment, the file-level backup includes generating a backup object which includes therein a plurality of data blocks, at least a portion of which are associated with a first file. In some embodiments, the file-level backup includes a manifest that is generated for each file for a plurality of files, etc. It should be noted that the manifests are stored in objects, for example, in S3. Each such object contains the manifests of multiple files (rather than one object per file). In some embodiments, the manifest includes a location, a pointer, an address, a mapping, and the like, for locating a data block associated with a file. In some embodiments, where data of a file is stored in compressed format by the filesystem, the manifest further includes compression metadata and a mapping between logical file offsets and physical locations of compressed data. According to an embodiment, each data block which is associated with a file of the filesystem is stored in a backup object of a plurality of backup objects.

At S330, a block-level backup is generated. In an embodiment, the block-level backup is generated utilizing deduplication, which is based on the file-level backup. For example, according to an embodiment, a data block which is stored in a backup object when generating the file-level backup, is not stored in the block-level backup.

In certain embodiments, the block-level backup allows restoring a system including each and every data block, while storing certain data blocks in locations that utilize file-level backup efficiency when restoring single files.

In an embodiment, the block-level backup includes fixed-size blocks, variable-size blocks, or any other suitable block format. In some embodiments, for example, where a fixed-size block is selected, the block size is selected to be a divisor of a block size of the file system. For example, where the block size of the filesystem is 8 kb, a block size of the block-level backup is 8 kb, 4 kb, etc.

At S340, restoration is initiated. In an embodiment, a restoration request includes a restoration of the entire system (i.e., block-level restoration), single file restoration, a combination thereof, and the like, and/or restoration of a requested logical file range of a file.

In some embodiments, where a single file is selected for restoration, multiple single files are selected for restoration, etc., a manifest of the file is accessed to determine which backup objects should be read. In some embodiments, the manifest is used to identify one or more records corresponding to the requested logical file range.

In an embodiment, in a file-level restoration, the backup objects are read, and the relevant data blocks are extracted from the backup object, allowing the file to be restored from the relevant data blocks. In some embodiments, where the file data is stored in a compressed format, compressed bytes are read based on physical locations indicated by the manifest and decompressed based on compression metadata indicated by the manifest to generate decompressed file data. In some embodiments, a restoration request includes a full system restoration, which includes restoring a block device. In an embodiment, this includes reading backup objects of the block-level backup and backup objects of file-level backup objects to extract from each data block, and initiating a full block device restoration from all the extracted data blocks.

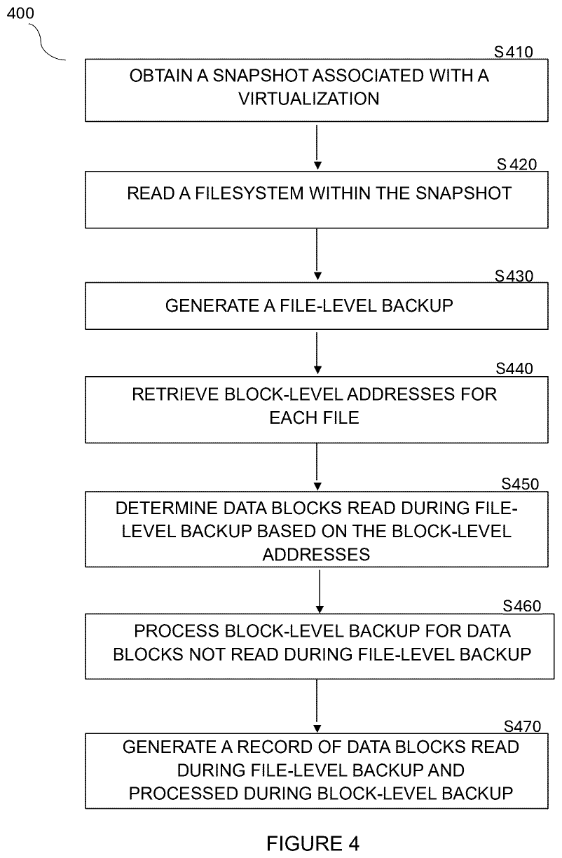

FIG. 4 is an example flowchart 400 of a dual scanning backup method including file-level and block-level processing, implemented in accordance with an embodiment.

At step 410, a snapshot associated with a virtualization is obtained. In some embodiments, a point-in-time snapshot of one or more volumes or block devices used within a virtualization environment may be obtained. The virtualization may be a virtual machine, container, or another type of software-based resource running on a hypervisor or cloud platform. Obtaining the snapshot allows subsequent read operations, whether file-level or block-level, to be performed against a consistent, unchanging data set. This snapshot may be initiated by a hypervisor Application Programming Interface (API), a volume manager, or a cloud storage service's snapshot mechanism.

At S420, a filesystem within the snapshot is read. Once the snapshot has been generated, the snapshot may be attached or otherwise made accessible in a read-only mode to a backup environment, such as a backup generator or backup host. In some embodiments, the filesystem may then be mounted to facilitate traversal of directories, retrieval of file metadata (such as size and modification timestamps), and subsequent reading of file contents. Accessing the snapshot may require specifying the filesystem type (e.g., ext4, NTFS, XFS, etc.) along with relevant parameters (e.g., block size), thereby ensuring that all files on the snapshot volume can be enumerated and accessed reliably. In some embodiments, reading the filesystem includes parsing on-disk filesystem metadata to determine whether data of a file is stored in a filesystem-specific compressed format and to identify physical byte ranges storing compressed data associated with the file.

At S430, a file-level backup is generated. For example, each file within the snapshot's filesystem is read and divided into multiple deduplication chunks (e.g., fixed-size or variable-size, such as using a rolling hash to determine chunk boundaries). Each chunk may be hashed and compared with a deduplication index, which may reside locally or on a remote backup repository. If an identical chunk is already present in the backup repository, a reference to that chunk is used to avoid duplication; otherwise, the new chunk is uploaded or recorded. By the end of this step, a file-level backup is formed, which may include a record (such as a manifest) that indicates which chunks belong to each file. This file-level backup process supports efficient single-file restores.

At S440, block-level addresses for each file are retrieved. After the file-level backup is generated, each file's logical extents may be mapped to the corresponding physical block addresses on the snapshot volume. In some embodiments, where data of a file is stored in a filesystem-specific compressed format, the mapping corresponds to physical byte ranges storing compressed data and associated logical file offset ranges. In some embodiments, the data structure (bitmap or table) is updated during or immediately after the file-level pass. This mapping can then be retrieved to determine the specific blocks that were already captured during the file-level scan. In some embodiments, a filesystem utility (e.g., filefrag) or filesystem API is employed to obtain these block-level offsets for each file. The offsets may be stored in a data structure, such as a bitmap or a table, indicating which blocks were already captured by the file-level scan. This mapping can be referenced to identify blocks that require re-reading in subsequent steps.

At 450, data blocks read during file-level backup are determined based on the block-level addresses. In some embodiments, physical blocks that have already been read and deduplicated in the file-level process can be identified using the retrieved addresses. In some embodiments, if a block is fully consumed by a file, that block may be marked as “already processed.” If a block includes space beyond the file's last byte, that leftover region may contain previously deleted data or content from other files, so that block may be flagged for re-evaluation. In addition, the identified addresses may be sorted in ascending order to help determine which blocks remain unprocessed. Accordingly, only blocks that potentially contain data outside the file-level scan are processed further, while fully accounted-for blocks are skipped.

At S460, a block-level backup is processed for data blocks not read during the file-level backup. In some embodiments, a block-level pass is performed over the snapshot volume (e.g., in ascending block order), referencing previously generated indicators of “already processed” blocks. Blocks identified as fully read at the file level are skipped. Only the remaining blocks (including partially used blocks) are read to ensure that any data not covered by the file-level pass is deduplicated. Once retrieved, the data in these blocks may be deduplicated against any existing index, and any resulting chunks are stored or referenced accordingly. Accordingly, any regions not captured by the file-level pass are included in the final backup.

At S470, a record of data blocks read during the file-level backup and processed during the block-level backup is generated. In some embodiments, this record includes or finalizes a block-level manifest referencing each block in the snapshot volume. The record may specify which blocks were accounted for by the file-level backup and which blocks were newly read in the block-level pass. By combining the file-level and block-level records, either an individual file or an entire volume can be restored. In some embodiments, additional post-processing steps (such as encryption, compression, or replication) may be applied to the resulting manifest and data objects. Once this record is prepared, the process concludes, yielding a comprehensive, deduplicated backup suitable for various restore scenarios.

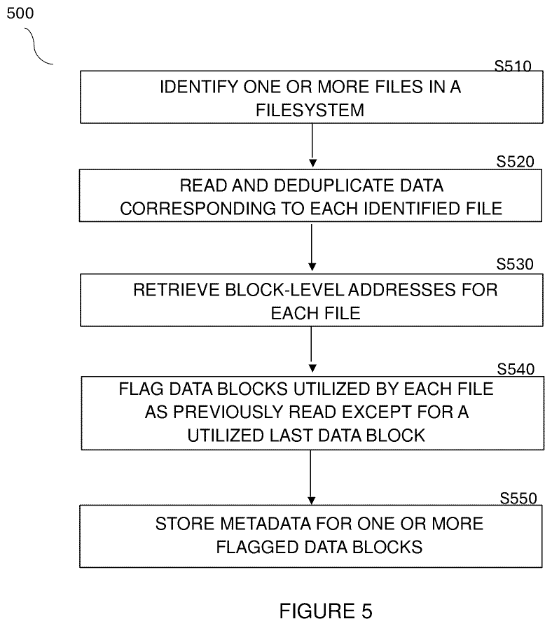

FIG. 5 is an example flowchart 500 of a file-level scanning method for identifying and flagging data blocks, implemented in accordance with an embodiment.

At S510, one or more files in a filesystem are identified. In some embodiments, files residing on the snapshot volume are identified by enumerating directory structures and reading file metadata such as filenames, sizes, and modification timestamps. This metadata may also include other relevant attributes (e.g., permissions or extended attributes) including attributes indicating whether data of a file is stored in a compressed format by the filesystem. By selecting the files to be processed for backup in this manner, the backup operation captures a consistent snapshot of the file system.

At S520, data corresponding to each identified file is read and deduplicated. In some embodiments, each file's content may be read in segments referred to as chunks. A chunk may represent a contiguous portion of file data that is processed as a single unit for deduplication. These chunks may be of fixed size (e.g., 4 KB or 8 KB), where the file is broken into uniform segments until the end of the file is reached, or variable size determined by content-defined boundaries, where a rolling hash or similar technique determines chunk boundaries based on the file's content. For example, if the chunk size is set to 8 KB and the file is 20 KB, two full 8 KB chunks are created, and a final 4 KB chunk holds the remainder. After each chunk is formed, it can be hashed and compared to an existing deduplication index. If an identical chunk is already stored, a reference is used rather than creating a new copy; otherwise, the new chunk is recorded. This chunk-based approach reduces redundant data storage when multiple files or multiple backup versions contain the same data segments.

At S530, block-level addresses for each file are retrieved. In some embodiments, following or during the chunking process, a utility or filesystem function may be employed to determine the physical block addresses where each file resides. These addresses can be stored in a structure such as a bitmap or a table, indicating that data in those blocks has already been read at the file level. By capturing these addresses, subsequent block-level processing can skip over blocks that have been accounted for through the file-level pass, thereby avoiding redundant reads.

At S540, data blocks utilized by each file are flagged as previously read except for a utilized last data block. For example, if a chunk fully occupies a data block, that block can be marked as already read, preventing redundant scanning in later steps. In some embodiments, a final chunk (the last portion of file data) may be smaller than preceding chunks if the file's length does not align exactly with a block boundary. For example, a block boundary may correspond to a fixed-size allocation unit used by the filesystem such as 4 KB. If the final chunk occupies only part of that data block, any leftover space may lie beyond the file's actual data range. Since that leftover region could contain data from another file or from deleted content, the partially filled block containing the final chunk (referred to as the last block) can be flagged for further evaluation in a subsequent backup phase. This additional evaluation ensures that unused portions of the block are not inadvertently excluded from the overall backup. By contrast, blocks that are fully occupied by the file can be designated as already processed, minimizing redundant reads of data.

At S550, metadata for one or more flagged data blocks is stored. Once blocks have been flagged or marked, metadata reflecting these designations may be recorded. This metadata may indicate which blocks were fully processed by the file-level pass and which last-block offsets remain subject to additional checks. In some embodiments, the metadata can also include references to each chunk's unique identifier or stored object address, allowing a future restore operation to locate the correct segments quickly. By maintaining structured records of block usage, this scanning process S500 facilitates efficient transitions to subsequent stages in the backup flow, ensuring that deduplication coverage remains accurate and complete.

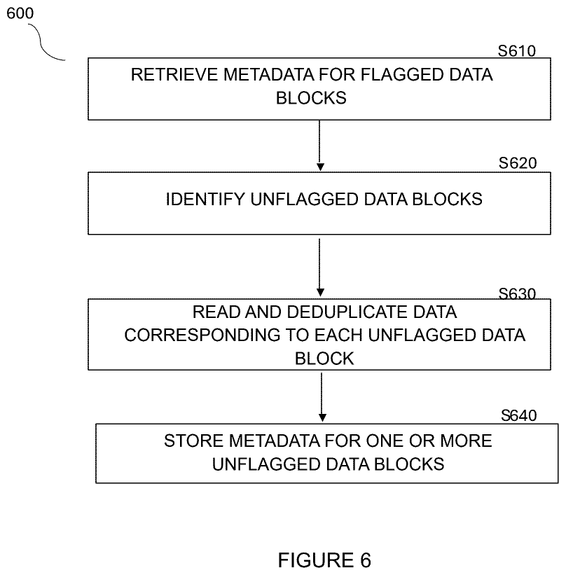

FIG. 6 is an example flowchart of a block-level scanning method for processing data blocks not previously flagged by a file-level scan, implemented in accordance with an embodiment.

At S610, metadata for flagged data blocks is retrieved. In some embodiments, a previous file-level scanning process flags certain blocks as requiring further scrutiny, for example, a partially utilized block that may contain data beyond a file's last byte. These flags may be stored in a bitmap, table, or manifest. Retrieving the metadata may involve examining each flagged block's entry to confirm why it was flagged (e.g., leftover space or uncertain data).

At S620, unflagged data blocks are identified. In some embodiments, any blocks not marked by the file-level process (i.e., unflagged) may be identified. By identifying these unflagged blocks, the backup procedure ensures that all data segments not explicitly confirmed at the file level are recognized for potential reading and deduplication.

At S630, read and deduplicate data in unflagged blocks. Once the unflagged blocks have been determined, data from each of the unflagged blocks may be read from the snapshot volume. In some examples, a deduplication algorithm is applied (such as chunk-based hashing), allowing the backup to store only references for any chunks already present in a deduplication index. New or unique chunks may be recorded in a backup repository. This process allows any segments not captured at the file level, including unallocated space that still contains relevant data, to be incorporated into the final backup.

At S640, store updated metadata for processed blocks. Upon completing the deduplication of unflagged blocks, updated metadata may be recorded in a suitable data structure. This metadata may reflect whether each block is now fully processed or whether any further actions are required. In some embodiments, references to chunk identifiers or object offsets are included, providing a clear mapping from block addresses to stored backup data.

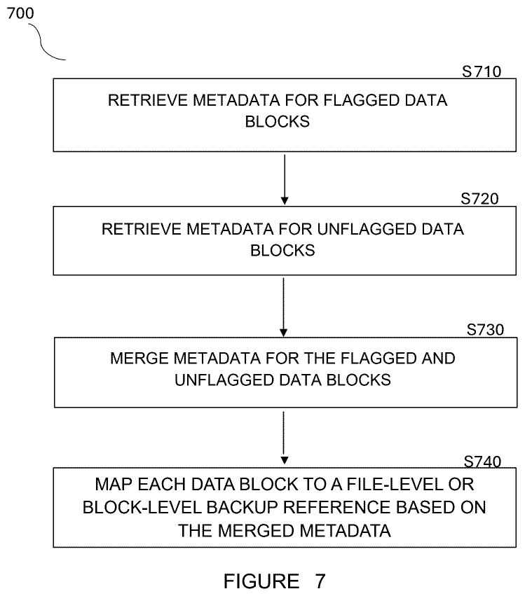

FIG. 7 is an example flowchart 700 of a method for merging metadata from the file-level and block-level backups, implemented in accordance with an embodiment.

At S710, retrieve metadata for flagged data blocks. In some embodiments, flagged data blocks represent those data blocks that were partially covered or otherwise marked for further evaluation during previous backup steps. For example, a partially utilized last block may have been flagged if leftover space extended beyond the file's final byte. Retrieving metadata for these flagged blocks may involve accessing a bitmap, table, or manifest that associates each flagged block with a reason or condition requiring additional evaluation (such as uncertain leftover space).

At S720, retrieve metadata for unflagged data blocks. In some embodiments, once flagged blocks are gathered, unflagged blocks are retrieved. These may include blocks that were deemed fully consumed at the file-level pass or blocks that were never flagged during a file level or block level pass. In some embodiments, unflagged blocks might also include blocks that align exactly with file boundaries, leaving no leftover space to trigger a flag.

At S730, merge metadata for the flagged and unflagged data blocks. Following retrieval of both sets of metadata, a merging operation may be performed to unify the references and statuses of each block. In some embodiments, the merging process aligns flagged entries (e.g., partially used blocks or uncertain leftover data) with unflagged entries (e.g., fully utilized blocks) to create a single repository or manifest that covers all blocks within a snapshot volume. During this merging step, any redundancies or overlaps may be resolved, for example, if the same block was flagged under multiple conditions or if new information clarifies a previously flagged block. The merging process results in a coherent view of how each block is represented in a final backup.

At S740, map each data block to a file-level or block-level backup reference based on the merged metadata. In some embodiments, this mapping involves associating each block with the appropriate reference, either from the file-level pass (e.g., a deduplicated chunk generated while scanning files) or from the block-level pass (e.g., a chunk captured when processing previously unflagged or partially used blocks). By applying the merged metadata in this manner, duplicate and overlapping references are resolved, thereby minimizing redundancy between the file-level and block-level records. In some embodiments, these references may be stored in a consolidated manifest or table, forming a unified resource for restoring any portion of the backup. This consolidated structure supports both single-file and entire-volume recoveries, ensuring that all data whether fully occupied by a file or flagged for additional verification remains accessible and accurately mapped to its deduplicated storage location.

In some embodiments, the merged metadata includes a block level manifest and a file level manifest that each reference a common set of deduplicated data objects. The block level manifest may be an address ordered list or index that associates each logical block address of the snapshot volume with a corresponding storage reference in a backup repository. The file level manifest may be an index in which a file identifier (e.g. an inode number, full path, or application-level handle) is associated with one or more storage references that collectively represent the data blocks storing the content of the file, and, in some embodiments, compression metadata and mappings between logical file offsets and physical byte ranges storing compressed data.

During a file level restore operation, the file level manifest may be evaluated independently of the block level manifest. The corresponding storage references are retrieved from the backup repository and the requested file is reconstructed without requiring restoration of the snapshot volume. In some embodiments, a restore request identifies a requested logical file range, and the file level manifest is used to identify one or more physical byte ranges storing compressed data corresponding to the requested logical file range and to obtain compression metadata for decoding the compressed data. Moreover, during a volume level restore operation, the block level manifest can be traversed (sequentially or in any order that optimizes I/O) to retrieve each storage reference from the backup repository and write the associated data blocks to a target device.

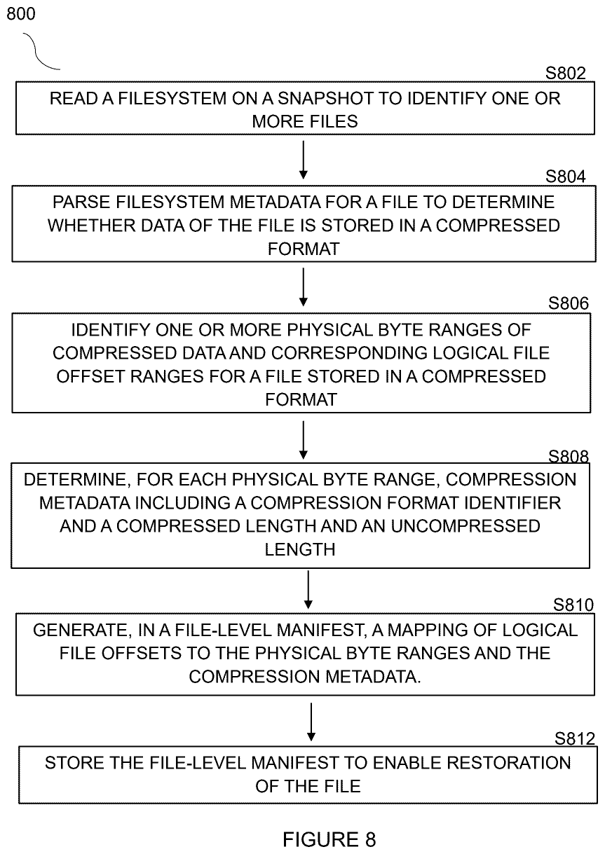

FIG. 8 is an example flowchart of a method for parsing a filesystem on a snapshot to generate a file-level manifest including compression metadata, implemented in accordance with an embodiment. In some embodiments, the method is performed by a backup system that generates and stores backup data in backup storage, while maintaining metadata that enables restoration of file data without requiring restoration of a snapshot volume. In some embodiments, the method is performed as part of generating a file-level backup, such as in connection with reading a filesystem to locate file data and generating file-level metadata that identifies where corresponding data is stored in backup storage.

At S802, a filesystem on a snapshot is read to identify one or more files. In some embodiments, the snapshot is a point-in-time representation of a block storage device associated with a virtualization, such that subsequent read operations are performed against a consistent view of stored data. In some embodiments, reading the filesystem includes making the snapshot accessible in a read-only mode to a backup environment and interpreting filesystem structures to enumerate files and directories. The one or more files may include regular files, directories, and each identified file may be associated with a file identifier such as an inode number, a path, a file record identifier, or another suitable identifier.

In some embodiments, reading the filesystem on the snapshot to identify the one or more files includes traversing directory structures and obtaining file metadata such as file names, file sizes, timestamps, and file attributes. In some embodiments, the filesystem is read using a filesystem-specific parser and/or a filesystem driver configured to interpret on-disk structures of a target filesystem. Examples of filesystems include NTFS, ext4, APFS, btrfs, ZFS, and other suitable filesystems. In some embodiments, the output of S802 includes a list or stream of file identifiers for further processing, and the method proceeds to evaluate, for at least a subset of the identified files, whether the file data is stored in a compressed format.

At S804, filesystem metadata for a file is parsed to determine whether data of the file is stored in a compressed format. In some embodiments, the filesystem metadata includes on-disk metadata maintained by the filesystem for representing file layout and file attributes, and parsing the filesystem metadata includes interpreting filesystem-specific structures rather than relying on generic operating system flags. In some embodiments, determining whether data of the file is stored in a compressed format is performed during backup/parsing time, and subsequent restore operations rely on stored metadata generated during the parsing rather than re-determining compression status at restore time. In some embodiments, the determination at S804 is performed per file and may be performed per file record, per data stream, and/or per extent record associated with the file.

In some embodiments, parsing the filesystem metadata for a file to determine whether data of the file is stored in a compressed format includes evaluating filesystem-specific indicators of compression stored in on-disk metadata. For example, for an NTFS filesystem, the compression status may be indicated by a compressed attribute in a file record and/or by compressed data runs within a $DATA attribute, and authoritative information may be derived from a runlist and compression unit layout. As another example, for a btrfs filesystem, a file extent item may indicate that compression is enabled when a compression field is not set to “NONE,” and authoritative information may be derived from file extent items in an extent tree. As another example, for a ZFS filesystem, a block pointer may indicate a compression setting that is not “OFF,” and authoritative information may be derived from block pointer metadata. As another example, for an APFS filesystem, a file record and/or data stream flags may indicate a compressed data representation. These examples are provided for illustration, and other filesystem-specific indicators may be used without departing from the scope of the disclosure.

At S806, one or more physical byte ranges of compressed data and corresponding logical file offset ranges are identified for a file stored in a compressed format. In some embodiments, the one or more physical byte ranges correspond to physical locations at which compressed bytes of the file are stored on the snapshot's underlying block storage, and the corresponding logical file offset ranges correspond to logical positions within the file as presented to an application or user. In some embodiments, identifying the one or more physical byte ranges and the corresponding logical file offset ranges includes identifying physical extents (or compression units) associated with the file and associating each physical extent with a corresponding logical offset range within the file. In some embodiments, the physical byte ranges are identified so that later restore operations may locate and read compressed bytes as stored, while reconstructing file content based on the corresponding logical file offsets.

In some embodiments, identifying the one or more physical byte ranges of compressed data and the corresponding logical file offset ranges for a file stored in a compressed format is performed by parsing filesystem-specific on-disk allocation and extent metadata. For example, for NTFS, a $DATA attribute runlist may be parsed to identify runs grouped into compression units, and each compression unit may map to one or more physical cluster ranges and a known logical file offset range. For btrfs, file extent items may be parsed to identify a physical starting location of a compressed extent and lengths corresponding to compressed size and uncompressed size. For ZFS, block pointers may be parsed to identify physical locations and corresponding logical and compressed sizes for blocks associated with the file. For APFS, file data extents may be parsed to identify compressed byte ranges and corresponding uncompressed lengths. In some embodiments, a key rule is that the mapping associates logical file offsets to physical compressed byte ranges, rather than attempting to map physical ranges back to logical ranges during restoration.

At S808, for each physical byte range, compression metadata including a compression format identifier and a compressed length and an uncompressed length is determined. In some embodiments, the compression metadata is determined per physical byte range (e.g., per extent, per compression unit, or per block), rather than merely per file, such that each portion of file data that is stored in a compressed format is associated with sufficient metadata for decoding. In some embodiments, the compression format identifier identifies a decompression algorithm or codec to be applied when restoring file data, and the compressed length and the uncompressed length respectively indicate a length of the compressed bytes to be read and a length of the resulting decompressed bytes for the corresponding physical byte range. In some embodiments, the compression metadata is recorded in the file-level manifest so that restore processing does not require re-parsing filesystem structures to interpret compression, and so that the compression metadata is not inferred at restore time.

In some embodiments, determining, for each physical byte range, the compression metadata including the compression format identifier and the compressed length and the uncompressed length includes selecting a compression format identifier from an enumerated set of supported compression formats. For example, for NTFS, the compression format identifier may indicate an LZNT1 format; for btrfs, the compression format identifier may indicate one of ZLIB, LZO, or ZSTD; for ZFS, the compression format identifier may indicate one of LZ4, GZIP, or ZSTD; and for APFS, the compression format identifier may indicate an APFS-associated format such as LZVN and/or ZLIB. In some embodiments, the compression metadata further includes one or more optional decoding parameters that affect decoding of the compressed bytes, such as a chunking unit size (when applicable) and/or filesystem-specific flags that affect decoding behavior. In some embodiments, compression level information is omitted where it is not required for decompression.

At S810, in a file-level manifest, a mapping of logical file offsets to the physical byte ranges and the compression metadata is generated. In some embodiments, the file-level manifest is a data structure that associates a file identifier with one or more records that collectively describe where data of the file is stored in backup storage and how the file data is to be reconstructed. In some embodiments, generating the mapping includes generating one or more extent records, each extent record associating (i) a logical file offset range, (ii) a physical byte range of compressed data, and (iii) compression metadata for decoding that physical byte range. In some embodiments, the mapping is generated such that the logical file offsets provide a logical ordering of file content, while the physical byte ranges provide storage locations for compressed bytes, thereby enabling reconstruction of file data based on physical reads of compressed bytes and decoding using the recorded compression metadata.

In some embodiments, generating, in the file-level manifest, the mapping of logical file offsets to the physical byte ranges and the compression metadata includes populating a table, index, or other suitable structure with fields that include a file identifier, a logical offset, an uncompressed length, a physical location (e.g., a storage reference identifying a backup object and an offset within the backup object), a compressed length, and a compression format identifier, along with any optional decoding parameters. In some embodiments, the mapping is generated so that the file-level manifest represents a compressed file using per-extent records rather than a single per-file compression indicator, thereby enabling restoration of a requested portion of a file at an extent granularity. In some embodiments, the file-level manifest is maintained separately from the backed-up data objects so that the file-level manifest may be evaluated without mounting a filesystem and without requiring restoration of a snapshot volume, while still identifying the storage locations and decoding metadata needed to restore file data.

At S812, the file-level manifest is stored to enable restoration of the file. In some embodiments, storing the file-level manifest includes storing the file-level manifest in backup storage, in a metadata repository, in an object store, or in another suitable storage location accessible to a restore workflow. In some embodiments, the file-level manifest is stored as part of a set of manifests, such as in one or more objects that store manifests for multiple files, and each manifest may include records for one or more extents of a corresponding file. In some embodiments, the file-level manifest is stored in association with a particular backup or restoration point, such that the file-level manifest corresponds to a particular snapshot and enables consistent restoration of file data associated with that snapshot.

In some embodiments, storing the file-level manifest to enable restoration of the file includes storing the mapping and compression metadata determined at S806 and S808 in a form suitable for subsequent retrieval and evaluation by a restore component. In some embodiments, the stored file-level manifest enables a restore operation to locate compressed bytes in backup storage based on the physical byte ranges indicated in the mapping and to interpret the compressed bytes using the compression metadata indicated in the manifest, thereby enabling restoration of file data in a manner that does not require mounting a filesystem. In some embodiments, the stored file-level manifest further enables restoration of a requested logical file range by selecting one or more extent records corresponding to the requested logical file range and reconstructing corresponding restored bytes based on the selected extent records.

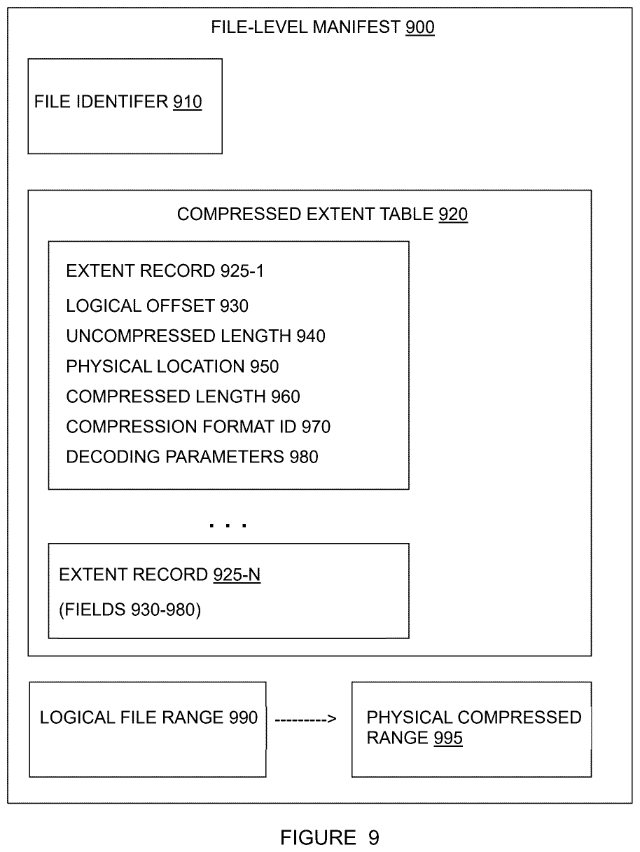

FIG. 9 is an example schematic illustration of a file-level manifest 900 including a compressed extent table mapping logical file ranges to physical compressed byte ranges, implemented in accordance with an embodiment. In some embodiments, the file-level manifest 900 is generated during backup/parsing time and stored as metadata separate from backed-up data, such that a restore operation relies on the file-level manifest 900 rather than mounting a filesystem or re-parsing on-disk filesystem structures at restore time.

In some embodiments, the file-level manifest 900 is associated with a file and includes a file identifier 910. The file identifier 910 identifies the file for which the file-level manifest 900 is generated and may include, for example, a pathname, an inode number, a file record identifier, and/or another suitable identifier that enables locating the corresponding metadata for the file.

In some embodiments, the file-level manifest 900 further includes a compressed extent table 920. The compressed extent table 920 includes one or more extent records 925 (e.g., extent record 925-1 through extent record 925-N) that represent, for the file, respective portions of file data stored in a compressed format by the filesystem. In some embodiments, the compressed extent table 920 implements a mapping in which logical file offsets are mapped to physical compressed byte ranges, such that the mapping is directed from logical file layout to physical storage locations of compressed data.

In some embodiments, an extent record 925-1 includes a logical offset 930 and an uncompressed length 940. The logical offset 930 indicates a logical position of a portion of the file within a logical file address space. The uncompressed length 940 indicates an amount of decompressed file data represented by the extent record 925-1, such that the logical offset 930 together with the uncompressed length 940 defines a logical file range represented by that extent record 925-1.

In some embodiments, the extent record 925-1 further includes a physical location 950 and a compressed length 960. The physical location 950 indicates a location of compressed data in backup storage associated with the extent record 925-1, such as a storage reference identifying a backup object (e.g., a blob identifier) and an offset within the backup object. The compressed length 960 indicates a length of compressed bytes stored at the physical location 950, such that the physical location 950 together with the compressed length 960 identifies (object, offset, length) for the compressed data. In some embodiments, a restore operation uses the physical location 950 and the compressed length 960 to read the compressed bytes from backup storage (e.g., based on storage reference and the offset within the backup object) without mounting the filesystem.

In some embodiments, the extent record 925-1 further includes a compression format ID 970. The compression format ID 970 identifies a compression format used by the filesystem for storing the compressed data represented by the extent record 925-1. In some embodiments, the compression format ID 970 is an enumerated identifier suitable for selecting a corresponding decoder during restore, for example, an identifier corresponding to NTFS LZNT1, btrfs ZLIB/LZO/ZSTD, ZFS LZ4/GZIP/ZSTD, and/or APFS-associated compression formats such as LZVN and/or ZLIB.

In some embodiments, the extent record 925-1 further includes decoding parameters 980. The decoding parameters 980 represent optional parameters that affect decoding of the compressed bytes, such as a chunking unit (when applicable) and/or filesystem-specific flags that affect decoding behavior. In some embodiments, the decoding parameters 980 omit compression level information when compression level information is not required for decompression.

The ellipsis shown between extent record 925-1 and extent record 925-N indicates that the compressed extent table 920 may include multiple extent records 925 for the file. In some embodiments, the multiple extent records 925 correspond to a filesystem-specific compression granularity, such as compression units, extents, or blocks, and each extent record 925 stores compression metadata per compressed extent rather than storing a single compression indicator per file.

In some embodiments, the file-level manifest 900 further conceptually represents a mapping from a logical file range 990 to a physical compressed range 995. The logical file range 990 represents a logical portion of file content, and may correspond to a range defined by one or more logical offsets 930 and uncompressed lengths 940 across one or more extent records 925. The physical compressed range 995 represents a physical byte range storing compressed data in backup storage (e.g., a byte range within one or more backup objects in object storage identified by storage references and corresponding offsets and lengths), and may correspond to one or more physical locations 950 and compressed lengths 960 across one or more extent records 925. In some embodiments, the arrow from the logical file range 990 to the physical compressed range 995 indicates the mapping rule that the file-level manifest maps logical file offsets to physical compressed byte ranges, and not the reverse.

In some embodiments, the file-level manifest 900 is used by a restore reader to restore file data in response to a restore request identifying a requested logical file range. In such embodiments, the restore reader selects one or more extent records 925 corresponding to (e.g., overlapping) the requested logical file range, reads compressed bytes from backup storage based on the physical location 950 and compressed length 960 for each selected extent record 925, and decompresses the compressed bytes based on the compression format ID 970 and any decoding parameters 980. In some embodiments, byte-range restore is supported at an extent granularity in which an entire compressed extent is fetched and decompressed and a requested logical sub-range is then extracted from the decompressed bytes.

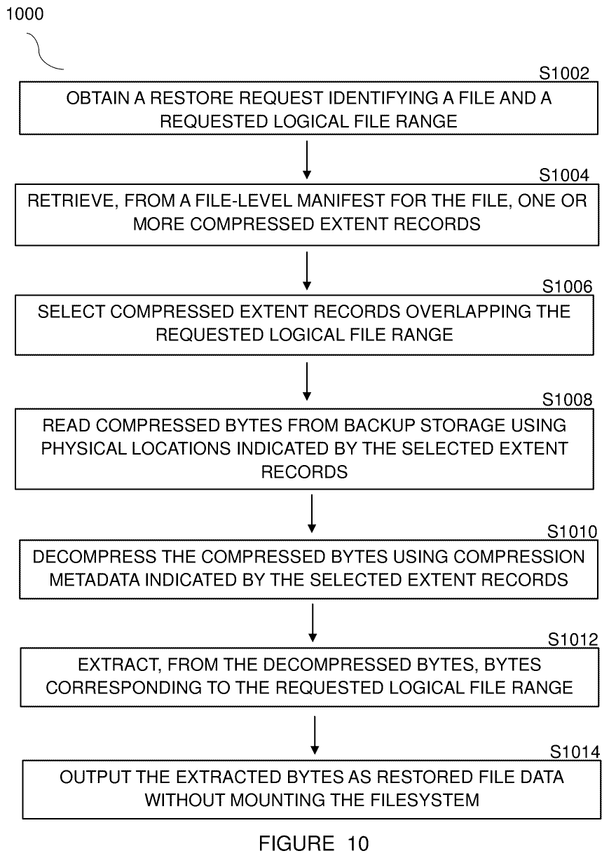

FIG. 10 is an example flowchart 1000 of a method for restoring file data stored in a compressed format based on a file-level manifest without mounting the filesystem, implemented in accordance with an embodiment. In some embodiments, the method is performed by a restore component that evaluates metadata stored separately from backed-up data, identifies where compressed file data resides in backup storage, decompresses the compressed file data using compression metadata stored in the file-level manifest, and outputs decompressed file data. In some embodiments, the file-level manifest includes a compressed extent table that maps logical file offsets to physical byte ranges storing compressed data, and includes per-extent compression metadata for decoding the compressed data.

At S1002, a restore request identifying a file and a requested logical file range is obtained. In some embodiments, the restore request is generated in response to a request to restore file content from a backup, and the restore request identifies the file using a file identifier such as a path, an inode, a file record identifier, or another suitable identifier. In some embodiments, the requested logical file range specifies a portion of the file to be restored, expressed as a logical offset and a length, as a start offset and an end offset, or using another suitable representation of a range of logical file bytes. In some embodiments, the requested logical file range corresponds to an entire file when the requested logical file range spans a full logical length of the file, thereby enabling both full-file restoration and byte-range restoration using a consistent restore request format.

At S1004, one or more compressed extent records are retrieved from a file-level manifest for the file. In some embodiments, the file-level manifest is metadata associated with the file that identifies where file data is stored and how file data is to be reconstructed during restoration. In some embodiments, the file-level manifest is generated during backup/parsing time and is stored as metadata separate from backed-up data, such that restore processing does not require mounting the filesystem or re-parsing filesystem on-disk structures to interpret compression. In some embodiments, a compressed extent record corresponds to a portion of file data that is stored in a compressed format by the filesystem and includes a mapping between a logical file offset range and a physical byte range storing compressed bytes of that portion of the file.

In some embodiments, retrieving the one or more compressed extent records from the file-level manifest includes accessing an extent table or index in which each compressed extent record includes at least (i) a logical offset (or logical file offset range), (ii) a physical location (e.g., a storage reference identifying a backup object in object storage (e.g., a blob identifier) and an offset within the backup object), (iii) a compressed length, (iv) an uncompressed length, and (v) a compression format identifier. In some embodiments, the physical location together with the compressed length identifies (object, offset, length) for compressed bytes associated with the compressed extent record. In some embodiments, the compression format identifier indicates a compression format used by the filesystem to store the file data in compressed form, and the compressed length and uncompressed length indicate, respectively, a size of the compressed bytes to be read and a size of decompressed bytes expected to be produced for the corresponding record. In some embodiments, the compressed extent record further includes one or more decoding parameters that affect decompression of the compressed bytes, such as a chunking unit and/or filesystem-specific flags that affect decoding.

At S1006, compressed extent records overlapping the requested logical file range are selected. In some embodiments, selecting the compressed extent records overlapping the requested logical file range includes comparing the requested logical file range to logical file offset ranges indicated by the retrieved compressed extent records and selecting those compressed extent records whose logical offset ranges overlap the requested logical file range. In some embodiments, the selected compressed extent records correspond to a granularity of filesystem compression, such as a compression unit, an extent, or a block, and each selected compressed extent record identifies a corresponding physical byte range storing compressed bytes. In some embodiments, the selection at S1006 is performed to identify a set of compressed extent records sufficient to satisfy the requested logical file range, including selecting multiple compressed extent records when the requested logical file range spans multiple compressed extents.

At S1008, compressed bytes are read from backup storage using physical locations indicated by the selected extent records. In some embodiments, reading the compressed bytes from backup storage includes reading compressed bytes corresponding to the physical byte ranges identified by the selected compressed extent records. In some embodiments, the physical locations indicated by the selected extent records correspond to offsets within stored backup data in backup storage (e.g., within one or more objects or blobs), and the physical locations are persisted as metadata such that the restore component can locate and read the compressed bytes without mounting the filesystem. In some embodiments, the physical locations are represented by a storage reference identifying a backup object and an offset within the backup object, such that the restore component reads compressed bytes from backup storage based on the storage reference and the offset. In some embodiments, reading the compressed bytes includes reading exactly a compressed length indicated by each selected extent record.

At S1010, the compressed bytes are decompressed using compression metadata indicated by the selected extent records. In some embodiments, decompression is performed by a restore reader rather than by the filesystem, such that the restore reader uses the compression metadata stored in the selected extent records to decode the compressed bytes and generate decompressed bytes corresponding to logical file content. In some embodiments, the compression metadata includes the compression format identifier and one or more length values, such that the restore reader selects a decompression algorithm based on the compression format identifier and applies the decompression algorithm to the compressed bytes read at S1008. In some embodiments, decompression at S1010 generates decompressed bytes in an amount corresponding to an uncompressed length indicated by the selected extent records.

In some embodiments, decompressing the compressed bytes using compression metadata indicated by the selected extent records includes selecting a decoder corresponding to a filesystem-specific compression format. For example, when the file is stored in a compressed format by an NTFS filesystem, the compression format identifier may indicate LZNT1 and the restore reader may apply an LZNT1 decoder. As additional examples, when the file is stored in a compressed format by btrfs or ZFS, the compression format identifier may indicate a standard format such as ZLIB, LZO, LZ4, GZIP, or ZSTD and the restore reader may apply a corresponding library implementation. When the file is stored in a compressed format by an APFS filesystem, the compression format identifier may indicate an APFS-associated compression format and the restore reader may apply a corresponding decoder. In some embodiments, the restore reader applies one or more decoding parameters indicated by the selected extent records, such as a chunking unit, when such parameters affect decoding of compressed bytes.

At S1012, from the decompressed bytes, bytes corresponding to the requested logical file range are extracted. In some embodiments, extraction at S1012 includes determining an overlap between the requested logical file range and a logical offset range associated with a selected extent record and selecting a corresponding sub-range of the decompressed bytes produced for that selected extent record. In some embodiments, partial or byte-range restoration is supported at a granularity of a compression unit or extent, such that the restore reader reads and decompresses an entire compressed extent corresponding to a selected extent record and thereafter extracts a sub-range corresponding to the requested logical file range. In some embodiments, when the requested logical file range spans multiple selected extent records, extracting bytes corresponding to the requested logical file range includes extracting sub-ranges from decompressed bytes generated for respective selected extent records and concatenating the extracted sub-ranges in logical order to form extracted bytes corresponding to the requested logical file range.

At S1014, the extracted bytes are output as restored file data without mounting the filesystem. In some embodiments, outputting the extracted bytes includes providing the extracted bytes to a restore target, writing the extracted bytes to a destination file, providing the extracted bytes as a stream, and/or otherwise outputting the extracted bytes as restored file data. In some embodiments, outputting the extracted bytes as restored file data without mounting the filesystem includes restoring file content using the file-level manifest and the selected extent records to locate compressed bytes and decompress the compressed bytes, without mounting a filesystem associated with a snapshot volume. In some embodiments, the restore method of FIG. 10 enables restoring file data stored in a compressed format by a filesystem in a manner that returns decompressed file content corresponding to the requested logical file range, while relying on stored metadata to identify physical locations of compressed data and to obtain compression metadata used for decompression.

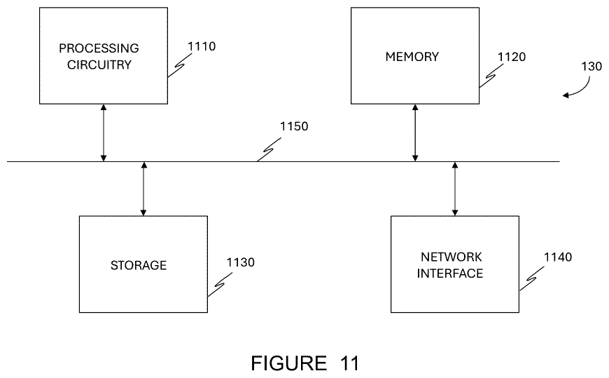

FIG. 11 is an example schematic diagram of a backup generator 130, implemented in accordance with an embodiment. The backup generator 130 includes, according to an embodiment, a processing circuitry 1110 coupled to a memory 1120, a storage 1130, and a network interface 1140. In an embodiment, the components of the backup generator 130 are communicatively connected via a bus 1150.

In certain embodiments, the processing circuitry 1110 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 1120 is a volatile memory (e.g., random access memory, etc.), a non-volatile memory (e.g., read-only memory, flash memory, etc.), a combination thereof, and the like. In some embodiments, the memory 1120 is an on-chip memory, an off-chip memory, a combination thereof, and the like. In certain embodiments, the memory 1120 is a scratch-pad memory for the processing circuitry 1110.

In one configuration, software for implementing one or more embodiments disclosed herein is stored in the storage 1130, in the memory 1120, in a combination thereof, and/or on a separate repository accessible via the network interface 1140. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 1110, cause the processing circuitry 1110 to perform the various processes described herein, including file-level scanning, block-level scanning, tracking, and skipping already-read blocks for deduplication, and the generation of a record or manifest for restoring both single files and entire volumes. In some embodiments, the instructions further cause the processing circuitry 1110 to parse filesystem metadata to determine whether data of a file is stored in a compressed format, identify physical byte ranges of compressed data and corresponding logical file offset ranges, determine compression metadata including a compression format identifier and compressed and uncompressed lengths, and generate, in a file-level manifest, compressed extent records mapping logical file offsets to physical compressed byte ranges and including the compression metadata. In some embodiments, the instructions further cause the processing circuitry 1110 to restore file data without mounting the filesystem by reading compressed bytes based on physical locations indicated by the compressed extent records, decompressing the compressed bytes using the compression metadata indicated by the compressed extent records, extracting bytes corresponding to a requested logical file range, and outputting restored file data In some embodiments, the memory 1120 or storage 1130 also maintains a data structure (e.g., a bitmap or table) that tracks which blocks have been read at the file level, thereby allowing the backup generator 130 to skip re-reading those same blocks during the block-level pass, consistent with the approaches described herein. In some embodiments, the memory 1120 or storage 1130 further maintains an extent table and/or other file-level metadata that stores, for a file stored in the compressed format, logical offsets, physical locations, compressed lengths, uncompressed lengths, compression format identifiers, and/or decoding parameters, thereby enabling restore processing based on stored metadata.

In some embodiments, the storage 1130 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 1140 is configured to provide the backup generator 130 with communication with, for example, the network 120, the virtualization 110, the backup storage 140, and the like, according to an embodiment. In some implementations, the backup generator 130 transmits deduplicated chunks or references to the backup storage 140 and receives file-level or block-level metadata via the network interface 1140, thereby implementing some of the processes disclosed herein. In some embodiments, such file-level metadata includes file-level manifests and compression metadata for restoring file data stored in the compressed format.

It should be understood that the embodiments described herein are not limited to the specific architecture illustrated in FIG. 11, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating a file-level manifest including compression metadata within a backup system, the method comprising:
reading a filesystem on a snapshot to identify one or more files;
parsing filesystem metadata for a file of the one or more files to determine whether data of the file is stored in a compressed format;
identifying one or more physical byte ranges of compressed data and corresponding logical file offset ranges for the file in response to determining that data of the file is stored in the compressed format;
determining, for each physical byte range of the one or more physical byte ranges, compression metadata including a compression format identifier, a compressed length, and an uncompressed length;
generating, in a file-level manifest, a mapping of logical file offsets to the one or more physical byte ranges and the compression metadata; and
storing the file-level manifest to enable restoration of the file.

2. The method of claim 1, wherein reading the filesystem on the snapshot includes identifying a file of the one or more files based on a file identifier comprising at least one of an inode number, a path, or a file record identifier.

3. The method of claim 1, wherein determining the compression metadata
comprises determining the compression metadata per physical byte range.

4. The method of claim 1, wherein generating the mapping comprises generating one
or more extent records, each extent record associating (i) a logical file offset range, (ii) a physical byte range of compressed data, and (iii) compression metadata for decoding the physical byte range.

5. The method of claim 1, wherein generating the mapping includes populating a structure having fields for at least one of: a file identifier, a logical offset, an uncompressed length, a physical location, a compressed length, and a compression format identifier.

6. The method of claim 1, wherein determining whether data of the file is stored in the compressed format is performed during parsing of the filesystem metadata for the file, and subsequent restore operations rely on stored metadata generated during the parsing rather than determining compression status at restore time.

7. The method of claim 1, wherein identifying the one or more physical byte ranges and corresponding logical file offset ranges includes identifying physical extents of compressed data associated with the file and associating each physical extent with a corresponding logical offset range.

8. The method of claim 1, wherein parsing the filesystem metadata comprises evaluating one or more filesystem-specific indicators of compression stored in on-disk metadata.

9. The method of claim 1, wherein the compression metadata further includes one or
more decoding parameters that affect decoding of the compressed data.

10. A non-transitory computer-readable medium storing instructions for generating a file-level manifest including compression metadata within a backup system, the instructions, when executed by one or more processors of a device, cause the device to:
one or more instructions that, when executed by one or more processors of a device, cause the device to:
read a filesystem on a snapshot to identify one or more files;
parse filesystem metadata for a file of the one or more files to determine whether data of the file is stored in a compressed format;
identify one or more physical byte ranges of compressed data and corresponding logical file offset ranges for the file in response to determining that data of the file is stored in the compressed format;
determine, for each physical byte range of the one or more physical byte ranges compression metadata including a compression format identifier, a compressed length and an uncompressed length;
generate, in a file-level manifest, a mapping of logical file offsets to the one or more physical byte ranges and the compression metadata; and
store the file-level manifest to enable restoration of the file.

11. A system for generating a file-level manifest including compression metadata comprising:
one or more processors; and
a memory storing instructions for generating the file-level manifest including the compression metadata, the instructions, when executed by the one or more processors, cause the system to:
read a filesystem on a snapshot to identify one or more files;
parse filesystem metadata for a file of the one or more files to determine whether data of the file is stored in a compressed format;
identify one or more physical byte ranges of compressed data and corresponding logical file offset ranges for the file in response to determining that data of the file is stored in the compressed format;
determine, for each physical byte range of the one or more physical byte ranges, compression metadata including a compression format identifier, a compressed length, and an uncompressed length;
generate, in a file-level manifest, a mapping of logical file offsets to the one or more physical byte ranges and the compression metadata; and
store the file-level manifest to enable restoration of the file.

12. The system of claim 11, wherein reading the filesystem on the snapshot includes identifying a file of the one or more files based on a file identifier comprising; and of an inode number, a path, or a file record identifier.

13. The system of claim 11, wherein determining the compression metadata comprises determining the compression metadata per physical byte range.

14. The system of claim 11, wherein generating the mapping comprises: generating one or more extent records, each extent record associating (i) a logical file offset range, (ii) a physical byte range of compressed data, and (iii) compression metadata for decoding the physical byte range.

15. The system of claim 11, wherein generating the mapping includes populating a structure having fields for at least one of:
a file identifier, a logical offset, an uncompressed length, a physical location, a compressed length, and a compression format identifier.

16. The system of claim 11, wherein determining whether data of the file is stored in
the compressed format is performed during parsing of the filesystem metadata for the file and subsequent restore operations rely on stored metadata generated during the parsing rather than determining compression status at restore time.

17. The system of claim 11, wherein identifying the one or more physical byte ranges and corresponding logical file offset ranges includes identifying physical extents of compressed data associated with the file and associating each physical extent with a corresponding logical offset range. corresponding logical offset range.

18. The system of claim 11, parsing the filesystem metadata comprises evaluating one or more filesystem-specific indicators of compression stored in on-disk metadata.

19. The system of claim 11, wherein the compression metadata further includes one or more decoding parameters that affect decoding of the compressed data.
